(19) United States
(12) Patent Application Publication
(10) Pub. No.: US 2009/0138362 A1
(43) Pub. Date: May 28, 2009

(54) SYSTEM AND METHOD FOR CONTEXT-ADAPTIVE SHAPING OF RELEVANCE SCORES FOR POSITION AUCTIONS

(75) Inventors: Stefan Schroedl, San Francisco, CA (US); Anandsudhakar Kesari, Santa Clara, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: Yahoo! Inc., Sunnyvale, CA (US)

(21) Appl. No.: 12/363,756

(22) Filed: Jan. 31, 2009

Related U.S. Application Data
(63) Continuation of application No. 11/760,069, filed on Jun. 8, 2007.

(51) Int. Cl. G06Q 30/00; G06Q 40/00; G06F 15/18; G06F 19/00; G06N 5/02

(52) U.S. Cl. 705/14; 705/37; 706/12; 706/46

(57) ABSTRACT

The present invention is directed towards systems and methods for ranking and providing advertisements in a position auction. The method of the present invention comprises receiving a search query and selecting at least one keyword based upon the search query. A list containing at least one keyword based upon the search query is returned and a list comprising at least one bid corresponding to the returned list of keywords is retrieved. The search query and list comprising at least one bid are used to train an offline simulator. The offline simulator creates a model that predicts optimal scoring factors. A priority score corresponding to each bid is computed using the optimal scoring factors and used to rank the list of bids. Advertisements are then provided corresponding to a plurality of the highest ranking bids.

### PRIORITY CLAIM

This application is a continuation of and incorporates by reference U.S. patent application Ser. No. 11/760,069, entitled “SYSTEM AND METHOD FOR SHAPING RELEVANCE SCORES FOR POSITION AUCTIONS,” filed on Jun. 8, 2007, by inventors Pavel Berkhin, et al., the disclosure of which is hereby incorporated herein by reference in its entirety.

### CROSS REFERENCE TO RELATED APPLICATIONS

The present application is related to the following co-owned U.S. Patent Applications:

U.S. patent application Ser. No. 11/281,919, entitled “SYSTEM AND METHOD FOR REVENUE BASED ADVERTISEMENT PLACEMENT,” filed on Nov. 16, 2005 and assigned attorney docket no. 600189.289;

U.S. patent application Ser. No. 11/281,940, entitled “POSITIONING ADVERTISEMENTS ON THE BASIS OF EXPECTED REVENUE,” filed on Nov. 16, 2005 and assigned attorney docket no. 600189.290;

U.S. patent application Ser. No. 11/281,917, entitled “SYSTEM AND METHOD FOR DISCOUNTING OF HISTORICAL CLICK THROUGH DATA FOR MULTIPLE VERSIONS OF AN ADVERTISEMENT,” filed on Nov. 16, 2005 and assigned attorney docket no. 600189.291;

U.S. patent application Ser. No. 11/479,186, entitled “SYSTEM AND METHOD FOR GENERATING FUNCTIONS TO PREDICT THE CLICKABILITY OF ADVERTISEMENTS,” filed on Jun. 29, 2006 and assigned attorney docket no. 600189.299;

the disclosures of which are hereby incorporated by reference herein in their entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to shaping relevance scores for position auctions. More specifically, the present invention is directed to systems and methods for providing allocation and payment rules to optimize search engine revenue via advertising position auctions.

### BACKGROUND OF THE INVENTION

Major search engines such as Yahoo!, which are advertisement providers, generate revenue by auctioning advertising space on keyword search result pages. This revenue is often a primary source of revenue for many search engines, globally generating roughly $7 billion a year for businesses. It is therefore important to advertisement providers that customer satisfaction and generated revenue be maximized to the extent possible.

A common technique that advertisement providers use (such as search engines) is that of a position auction. When users search for keywords in a corpus of documents, the results are returned to along with relevant advertisements, usually located on the top, bottom or side of the returned results. In a position auction, advertisers submit bids corresponding to desired keywords. For example, a company may decide to bid $1 per user click for the keyword “acoustic guitar”. Subsequent users may decide to bid on the same keyword with a higher or lower bid. After advertisers submit bids and corresponding advertisements, the advertisement provider ranks the advertisements to determine an appropriate order or position for presentation of the advertisements to the user.

Techniques to rank advertisements in position auctions include rank-by-bid and rank-by-revenue. In a rank-by-bid scheme, advertisers are ranked according to the amount of their bid. This scheme is deficient as it allows an advertiser to simply bid more for a keyword to guarantee their advertisement is shown in response to submission of a given keyword by a user. This scheme may also reduce the value generated to the advertisers. The rank-by-revenue scheme ranks advertisers according to the product of their bid multiplied by their quality score (or “click-through rate” in an alternative embodiment), which is an estimate of the rate at which users click an advertisement, which may be normalized for position.

Both models are not optimal in terms of revenue generated for a search engine. As previously stated, the rank-by-bid model suffers from advertisers with low click-through rates flooding the bid list and wasting advertising space with unwanted advertisements. Although the bid price is higher for these advertisements, they are not selected often, thus degrading the amount of revenue generated for the advertisement provider (e.g., search engine). The rank-by-revenue approach results in a less than optimal solution as it results in lower payments by advertiser; also diminishing the revenue that an advertisement provider generates. Rank-by-bid, in addition to non-optimal revenue, also degrades user experience.

### SUMMARY OF THE INVENTION

The present invention is directed towards systems and methods for context-adaptive shaping of relevance scores for use in ranking position auctions. The system of the present invention comprises a network communicatively coupled to a plurality of user devices and a plurality of advertiser devices. A content server is further coupled to the network and is operative to receive search queries from said user devices and provide advertisements based upon a derived priority score for each advertisement. In accordance with one embodiment, advertisements are distributed among vacant slots of a search results page.

The content server may comprise a query analyzer operative to receive search queries and extract relevant keywords (which may include groups or clusters of keywords), a rank generator operative to determine said quality score for an advertisement and an ad generator operative to generate advertisements corresponding to a user search query.

The content server may also comprise a model produced by an offline simulator operable to receive a set of queries and a corresponding set of advertisements to the queries. The offline simulator is further operable to compute a training gamma value (also referred to as a scoring factor) for the corresponding set of advertisements, analyze the training gamma value and train the model to predict optimal gamma values. The model determines a query-specific way of combining bid and quality score into the priority score used for ranking of advertisements.

The rank generator receives a list of advertisements from the ad generator, receives corresponding advertisement bids from a bid data store and receives corresponding click through data from a click data store. In one embodiment, the derived priority score comprises multiplying an advertiser bid by the result of a monotone, concave function applied to the quality score. The function comprises an optimal gamma value predicted by a model produced by an offline simulator. In an alternative embodiment, the derived priority score comprises utilizing bid credits for advertiser bids. The derived priority score may be computed at runtime, although alternative embodiments exist where the derived priority score is computed prior to submission of a user search query.

The present invention is further directed towards a method for ranking advertisements in a position auction. The method of the present invention comprises receiving a search query and selecting at least one keyword based upon said search query. In accordance with one embodiment, a user search query is received via a query entered into an HTML form element.

A list of at least one advertisement corresponding to at least one keyword identified and a priority score is computed corresponding to each advertisement in the list. In one embodiment, the priority score is a product of an advertiser bid and a monotone, concave function applied to the quality score corresponding to said advertisement. The function comprises an optimal gamma value predicted by a model produced by an offline simulator. In an alternative embodiment, the priority score is computed by assigning bid credits for each advertiser. The priority score may be computed at runtime, although alternative embodiments exist where derived priority score is computed prior to a user search query is submitted.

After calculating a priority score for one or more advertisements, the advertisements are ranked according to the calculated priority score and at least one of the retrieved advertisements corresponding to the highest ranked priority score is provided to the user. In accordance with one embodiment, advertisements are distributed among vacant slots of a search results page. In one embodiment, advertisers are charged a price equal to the minimum price necessary to keep a current ranked position, plus a small optional increment. This pricing rule is referred to as the “next price” or, alternatively, “generalized second price” auction rule.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating one embodiment of a system for dynamically or statically ranking and providing advertisements in a position auction;

FIG. 2 presents a block diagram illustrating one embodiment of a system for training of a machine learned model in an offline simulator.

FIG. 3 presents a flow diagram illustrating one embodiment of a method for dynamically ranking and providing advertisements in a position auction; and

FIG. 4 presents a flow diagram illustrating one embodiment of a method for statically ranking and providing advertisements in a position auction.

FIG. 5 presents a flow diagram illustrating one embodiment of a method for training of a machine learned model in an offline simulator.

### DETAILED DESCRIPTION OF THE PREFERRED EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

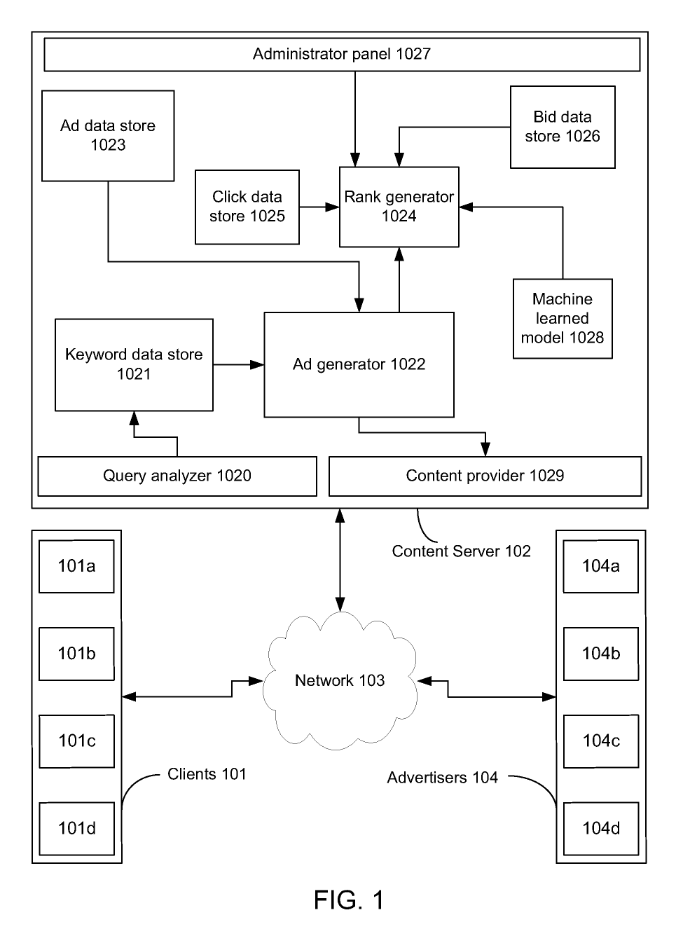

FIG. 1 presents a block diagram depicting one embodiment of a system for shaping relevance scores for position auctions. According to the embodiment illustrated in FIG. 1, a system for shaping relevance scores for position auctions comprises clients 101, advertisers 104, content server 102 and a network 103.

According to the embodiment illustrated in FIG. 1, client devices 101a, 101b, 101c and 101d are communicatively coupled to a network 103, which may include a connection to one or more local and wide area networks, such as the Internet. According to one embodiment of the invention, a client device 101a, 101b, 101c and 101d is a general purpose personal computer comprising a processor, transient and persistent storage devices operable to execute software such as a web browser, peripheral devices (input/output, CD-ROM, USB, etc.) and a network interface. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Advertisers 104a, 104b, 104c and 104d are communicatively coupled to the network 103.

Content server 102 is also communicatively coupled to network 103 and is operative to receive data from client devices 101 and advertisers 104. In one embodiment, the content server 102 is operative to receive search queries from client devices 101. Search queries may be in the form of text strings, e.g., keywords, which a user may enter into an HTML form element such as a text box. Content server 102 may further be operative to return search results to a client 101a, 101b, 101c and 101d, as well as advertisements. In addition to communicating with the client devices 101, content server 102 may be further operative to communicate with advertisers 104. In one embodiment, the content server 102 may be operative to receive bid information for a search keyword from one or more advertisers 104. Additionally, content server 102 may be operative to return statistical data regarding an advertiser to said advertiser. In alternative embodiments, the content server 102 may be operative to communicate other relevant data to and receive other relevant data from a given advertiser 104, including, but not limited to, billing information, analytics information and any other relevant information known in the art.

Content server 102 comprises a query analyzer 1020, keyword data store 1021, ad generator 1022, ad data store 1023, rank generator 1024, click data store 1025, bid data store 1026, administrator panel 1027, machine learned model 1028 and content provider 1029. An advertiser 104a, 104b, 104c and 104d places a bid by submitting a bid request to content server 102. A bid corresponds to an amount paid per user interaction, such as a user click. In one embodiment, the content server 102 provides a list of available keywords stored in keyword data store 1021. Alternatively, an advertiser 104a, 104b, 104c and 104d may be able to select keywords not present in keyword data store 1021. After an advertiser 104a, 104b, 104c and 104d selects the desired keywords, a bid is submitted and stored within bid data store 1026.

After a keyword is selected by an advertiser 104a, 104b, 104c and 104d, a corresponding advertisement is selected by an advertiser 104a, 104b, 104c and 104d and submitted to the content server 102 for storage within an advertisement data store 1023. In accordance with some embodiments, an advertisement that an advertiser 104a, 104b, 104c and 104d submits may be a textual advertisement comprising a product title, brief product description and a URL containing the product details. In alternative embodiments, an advertiser 104a, 104b, 104c and 104d may submit advertisements that comprise graphical information, audio information, video information or any advertising medium known to those of skill in the art.

When a user submits a query using a web search engine, query analyzer 1020 receives the search query from the user. Query analyzer 1020 may determine the keywords contained within a received user query. For example, if a user enters the query “Tottenham Hotspur tickets”, query analyzer 1020 may determine the query contains two keywords, the team “Tottenham Hotspur” and the object “tickets”. Query analyzer 1020 determines keywords that a query contains by querying keyword data store 1021. Determining groups of semantically related terms from a query comprising one or more keywords may be conducted in accordance with the systems and methods described in commonly owned U.S. Pat. No. 7,051,023, entitled “SYSTEMS AND METHODS FOR GENERATING CONCEPT UNITS FROM SEARCH QUERIES,” filed on Nov. 12, 2003, the disclosures of which is hereby incorporated by reference herein in its entirety. Keyword data store 1021 may comprise a flat data file, relational database, object oriented database or other storage means known in the art. If a match is found within the keyword data store 1021, the match is forwarded to ad generator 1022.

After ad generator 1022 receives the keywords, the ad data store 1023 is queried for advertisements corresponding to or otherwise matching the extracted keywords. Ad data store 1023 may comprise a flat data file, relational database, object oriented database or other storage means known in the art. In one embodiment, the advertisements stored within ad data store 1023 may comprise textual advertisements containing an advertisement title (such as “Discount Airline Ticket”), a description supplementing the title (such as “Find low airfares & discount tickets on American Airlines at AA.com.”) and a URL associated with the advertisement (such as “www.aa.com”). Ad data store 1023 may also maintain other advertisement media known to those of skill in the art.

When advertisements corresponding to the received keywords are retrieved, rank generator 1024 may order the advertisements by priority score. According to one embodiment, the rank generator 1024 receives the keyword from the ad generator 1022 and fetches a bid list from bid data store 1026. Bid data store 1026 may comprise a flat data file, a relational database, an object oriented database or any storage method known in the art. Rank generator 1024 receives a list of advertisers bidding on a selected keyword and proceeds to determine a priority score for a given advertisement. Techniques for calculating the priority score in accordance with various embodiments of the invention are described in greater detail herein. Rank generator 1024 may further include advertisement pricing according to a pricing rule such as the “generalized second price” auction rule.

Rank generator 1024 is further communicatively coupled to click data store 1025. Rank generator 1024 receives click data from click data store 1025. Click data store 1025 contains information relating to user interaction with one or more advertisements. In accordance with one embodiment, click data for a given advertisement may comprise a function of the number of impressions for a given advertisement and the number of times one or more users have clicked on the given advertisement in response to an impression for the given advertisement, which may be recorded whenever a user interacts with the given advertisement. In accordance with one embodiment, whenever a user clicks on a given advertisement hyperlink, data is returned to the content provider for storage in the click data store 1025 indicating that a user has selected the given advertisement. In turn, a counter is incremented indicating another user has selected the advertisement. Impression data is also returned to the click data store 1025 in response to the display of an advertisement to a user. Alternative embodiments may exist wherein additional data is collected in lieu of or in conjunction with the preceding example. Techniques for collecting information regarding advertisement impression and selection, such as redirection, are well known to those of skill in the art.

In accordance with one embodiment, the priority score of a given advertisement corresponds to the price of the bid multiplied by function whose input is the quality score an advertisement receives, as is Equation 1 below illustrates. The quality score may be a measure of the “clickability” or “relevance” for the given advertisement, which according to one embodiment is based on a position-normalized click through rate (CTR). The quality score may also comprise various combinations of an actual or estimated click through rate, clickability metric, relevance score, advertisement quality score, advertiser quality score, user satisfaction score or any other measure of advertisement quality. Additionally, the quality score may comprise one or more relevance features in addition to click through rate history, such as the appearance of query terms in a given advertisement.

Priority score=Bid*ƒ(quality score) Equation 1

In accordance with one embodiment, the function “ƒ” corresponds to a monotone, concave function. A monotone, concave function has the properties of increasing or decreasing as the input parameter increases or decreases and satisfies the equality of Equation two for any points x and y and any t=[0, 1]:

ƒ(tx+(1−t)y)≧tƒ(x)+(1−t)ƒ(y) Equation 2

The use of a monotone, concave function allows the content server 102 to exert control over which advertisements are shown on a search results page at a finer granularity.

The function “ƒ” allows for the tradeoff between the relative weight given to a bid and the relevance of the bid as Equation 3 illustrates:

ƒ(quality score)=quality scorêgamma Equation 3

The factor value “gamma” provides an adjustable variable that allows for a continuous transition or sweep between predetermined gamma values and may comprise any integer or decimal value may be used as the upper and lower bounds (e.g., between 0 and 1) for performing a gamma sweep. Gamma represents and determines the parameters for the monotone, concave function. A maximum revenue value may be achieved at an intermediate value between the predetermined gamma values, depending on the bid context. Lowering the value of gamma results in a decrease of CTR and an increase in price per click (PPC). According to one embodiment, a heuristic approach is used to decrease gamma linearly in accordance with the number of results for a given user query. By decreasing the value of gamma, a target performance metrics such as revenue per search (RPS), may be optimized. A trade-off between one or more additional performance metrics may be necessary to optimize a target performance metric. For example, PPC and CTR may need to be compared and adjusted accordingly by gamma to optimize RPS. In other embodiments, gamma may also be adjusted to achieve maximum CTR and PPC values. Adjusting gamma on a per-query basis allows for fine-tuning of results according to intended audience and business targets.

In one embodiment, machine learned model 1028 may be used as part of the ranking system. For example, machine learned model 1028 outputs the gamma value for a given query on the basis of features associated with the set of candidate ads. Features of the candidate ads include, but are not limited to, relevance scores, historical click information, match type confidences and other ad characteristics that may be useful in ad bidding. On the basis of these features, machine learned model 1028 may output a gamma value, which may be used to determine ranking of the candidate ads. Machine learned model 1028 may be trained to predict an optimal gamma value with respect to a target performance metric, which may include, for example, maximum RPS, CTR or PPC. Rank generator 1024 may receive the gamma values predicted by the one or more models produced by an offline simulator, which the rank generator 1024 may use to determine the ranking of ads. Accordingly, a gamma value may be used to trade off between bid amount and relevance for calculating the final score to determine the displayed order of ads.

According to another embodiment, a the system may utilize a convex function whereby the quality score is raised to a power gamma that is greater than 1, thereby “overweighting” clicks and giving a bigger discount than a pure ranking. By utilizing a server defined function, the server may set the function so that enough value is generated to the advertiser while still keeping payments high enough to ensure enough revenue is generated by the content server 102.

In accordance with an alternative embodiment, a monotone, concave function may be replaced with the use of “bidding credits” that the content server 102 provides to advertisers 104a, 104b, 104c and 104d. In accordance with this embodiment, the content server 102 may only require that an advertiser 104a, 104b, 104c and 104d pay a fraction of the prices they face, or equivalently a fraction of their clicks may be received for free. The use of “bidding credits” achieves an identical result to that obtained by using a monotone, concave function. Bidding credits, however, may allow the content server 102 to avoid explicitly setting the weight of user clicks through a function.

As shown in FIG. 1, rank generator 1024 is further communicatively coupled to administrator panel 1027. Administrator panel 1027 is operative to allow a server administrator to configure the properties of at least the rank generator 1024. In accordance with one embodiment, a server administrator may modify the function represented by “ƒ” in Equation 1. For example, an administrator may determine that ƒ(quality score) may be set as log(quality score) and may set the appropriate value of ƒ in the rank generator 1024.

The rank generator 1024 orders the advertisements by priority score and one or more of the ordered advertisements are selected for display to the user. The number of advertisements that the rank generator 1024 selects may correspond to the number of free advertising slots available on a website, e.g., a search result page that a search engine produces. For example, a search results page may contain three slots corresponding to the top, right hand side and bottom of the page. In accordance with one embodiment, the highest ranking advertisement is placed in the most visible advertising slots. The advertising slot located at the top of a search result page may be considered the most visible advertising slot, therefore, the advertisement or advertisements with the highest priority score may be placed in these one or more slots. Subsequently, advertising slots to the right of the returned search results may be determined to be the second most visible slots, and one or more remaining advertisement from the ranked list may be placed in this slot. Finally, a slot at the bottom of a page of search results may be determined to be the least visible slot and therefore will be filled last. It should be noted by those of skill in the art that embodiments of the present invention are not limited to placement of ranked advertisements on a search result page and may be applicable to any systems that utilize ranked lists of items in which users pay for placement of items in the list, e.g., a real estate listing site, personals/dating site, etc.

Advertisements and slot positions may be sent to content provider 1029. Content provider 1029 may be operative to combine the advertisements with the data in the query result set, returning the combined resource to clients 101a, 101b, 101c and 101d across the network 103.

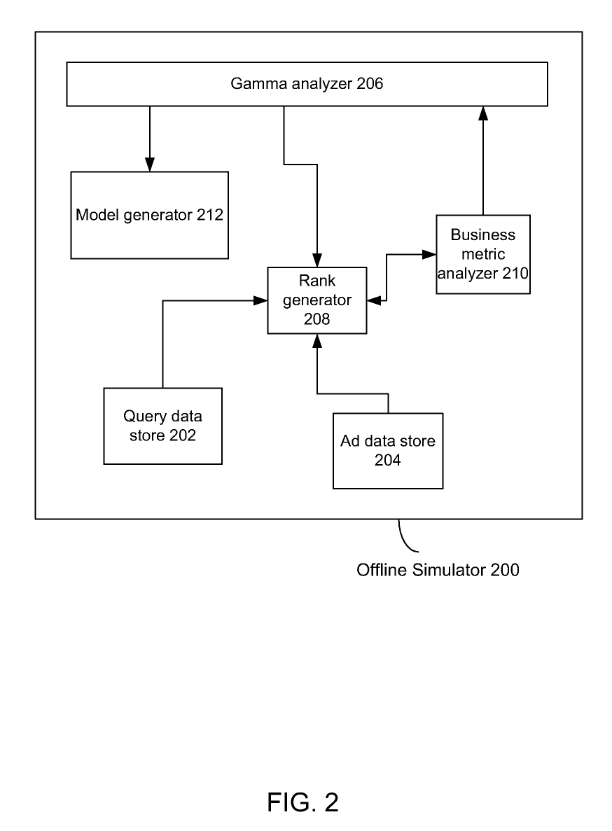

FIG. 2 presents a block diagram depicting one embodiment of a system for training a machine learned model. In one embodiment, offline simulator 200 is a standalone module separate from the system illustrated by FIG. 1. Offline simulator 200 comprises a query data store 202, ad data store 204, gamma analyzer 206, rank generator 208, business metric analyzer 210 and model generator 212. Data store 202 and ad data store 204 are communicatively coupled to gamma analyzer 206. Query data store 202 stores query input from previously submitted user queries. Gamma analyzer 206 samples queries from query data store 202. Advertisements associated with the sampled queries are retrieved from ad data store 204. Gamma analyzer 206 selects a training gamma value for a given query sample and its corresponding set of advertisements.

When advertisements corresponding to the query sample are retrieved, rank generator 208 may order the advertisements by priority score. According to one embodiment, the rank generator 208 receives the query from the gamma analyzer 206 and prices the advertisements according to a pricing rule. Rank generator 208 may also compute the quality score of the advertisements. Business Metric Analyzer 210 evaluates business metric data from rank generator 208. Gamma analyzer 206 receives business metric data from business metric analyzer 210 and analyzes the business metric data associated with the training gamma value for the corresponding query advertisement set.

In one embodiment, business metric data may be estimated through use of a simulation utilizing information, such as historical click data, to predict the changes in clicks for various ranking or placement of advertisements. A correlation may be made from historical click data to determine the effect of advertisement rank and placement on click activity. As such, rank normalization of click data may be performed to accurately predict click activity.

A predetermined amount of training gamma values may be selected and analyzed by gamma analyzer 206. In one embodiment, training gamma values may be iteratively selected or swept through a predetermined interval. Gamma analyzer 206 records all selected training gamma values and their corresponding business metric data. Data recorded by gamma analyzer 206 is used to determine an optimal gamma value for a given query advertisement set.

When an optimal gamma value for a query advertisement set has been determined, model generator 212 trains and creates machine learned model 1028 from data recorded by gamma analyzer 206. An optimal gamma value may be a “best effort” value due to a limited amount of data gathered using a predetermined amount of training gamma values. Models produced within offline simulator 200 may predict optimal gamma values for queries and the advertisements corresponding to the queries without the rigorous analysis performed by offline simulator 200.

State-of-the-art techniques such as support vector machines, neural nets, decision trees, etc. may be used in the machine learning procedure. Additional components, not illustrated in the figures, may be used in the system for training a machine learned model. Offline simulator 200 may have additional input features for learning such as, historical click features, match type confidences, etc. belonging to the set of candidate advertisements. The target function of the learning machine, used to create machine learned model 1028, may be an optimal gamma value, a model minimized loss function between target and prediction, e.g., least squares, etc.

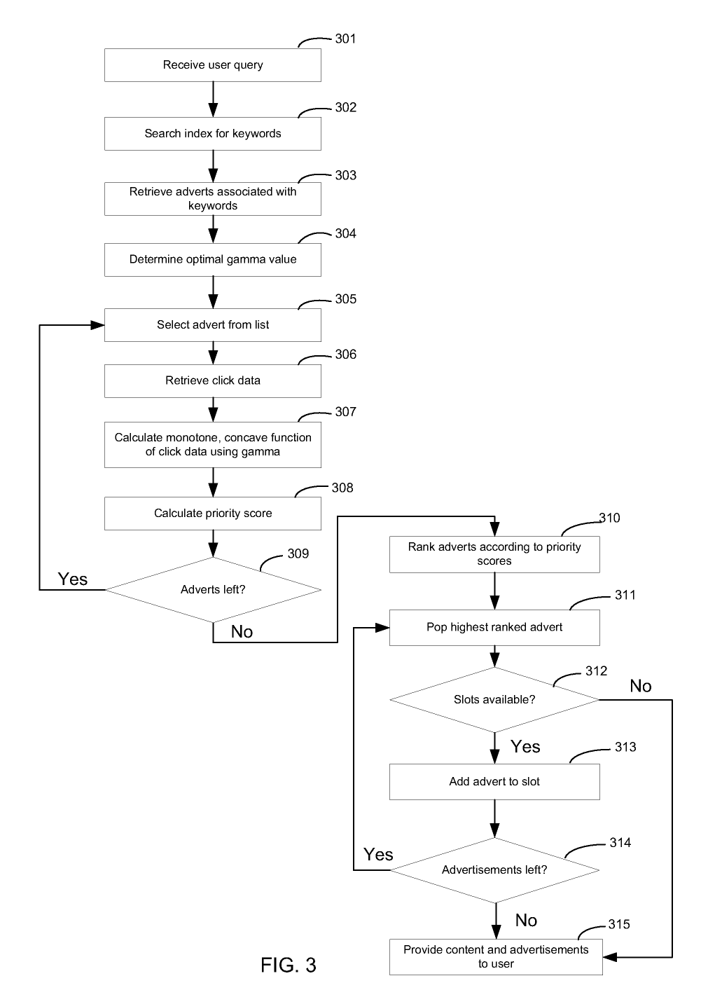

FIG. 3 is a flow diagram illustrating one embodiment of a method for dynamically ranking and providing advertisements in a position auction. A user query is received, step 301, which may correspond to the search terms requested of a search engine, such as through an HTML text box. After a user query is received, an index is searched for corresponding keywords, step 302. For example, if an index of keywords contains the terms “Tottenham”, “tickets”, “soccer” and “London” and a user query comprises “tottenham hotspur tickets”, the keywords “Tottenham” and “tickets” will be extracted from the user query. The extraction of keywords from a given user query may be performed in accordance with the systems and methods described in the applications previously incorporated herein by reference in their entirety. Extracted keywords may attempt to represent a user query with a minimal dictionary of terms understandable by a server system.

After at least one keyword is extracted from the user query, a list of advertisements corresponding to the keyword are retrieved, step 303. With the at least one extracted keyword from the user query and the list of advertisements corresponding to the keyword, an optimal gamma value may be determined, step 304. Machine learned model 1028 may determine the optimal gamma value according to a specified target performance metric. The optimal gamma value is assigned per a given list of advertisements.

When the optimal gamma value has been determined, a first advertisement is selected from the list of advertisements, step 305. The choice of an advertisement is inconsequential, as the present embodiment contemplates traversal of the list and the analysis of advertisements contained therein. For the selected advertisement, click data corresponding to the advertisement is retrieved, step 306. In accordance with one embodiment, click data for an advertisement may comprise the number of times users have clicked on the selected advertisement (or may more generally comprise the recordation of a user interaction with the advertisement, e.g., a mouse over event) in conjunction with the number of impressions for the selected advertisement. Whenever a user clicks on an advertisement hyperlink or the advertisement is shown to the user, data may be returned to the advertisement provider indicating a user has selected the advertisement or viewed the advertisement, respectively. Alternative embodiments may exist wherein additional data is collected in lieu of or in conjunction with the preceding example.

A quality score may also be determined in step 306, from the retrieved click through data. After click through data is retrieved in step 306, a monotone, concave function, which comprises the optimal gamma value, may be applied to the quality score based on click data, step 307. A monotone, concave function has the properties of increasing or decreasing as the input parameter increases or decreases and satisfies the equality ƒ(tx+(1−t)y)≧tƒ(x)+(1−t)ƒ(y) for any points x and y and any t=[0, 1].

The use of a monotone, concave function allows the advertisement provider to maintain a finer granularity of control over the combination of the bid and quality of advertisements provided on the search results page. For example, a function of the form ƒ(x)=log(x+c); for c>0 is an example of a monotone, concave function which may be utilized to “cap” the effect of the click through rate. That is, log(x) increments one unit (0→1) over the range of inputs 1 to 10. Log(x) then increments one more unit (1→2) over the interval 10 to 100. This property of the log function may prevent an advertiser from having a bloated quality score, as the nature of the logarithmic function requires a tremendous number of clicks to increase the quality score as clicks are accumulated. An alternative example is provided by the function f(x)=x^{c}, for 0<=c<=1. The preceding examples are intended to be exemplary in nature, and a number of other functions may be utilized, as decided by a server administrator, other server side technician or automated software process.

After the results of the monotone, concave function are calculated in step 307, a final priority score is determined for the selected advertisement, step 308. In accordance with one embodiment, a priority score is calculated by multiplying the advertiser bid amount by the result of the monotone, concave function calculation. After the priority score is determined, the list of advertisements is queried to determine if there are additional advertisements remaining in the list of advertisements that are responsive to the user keywords, step 309. If advertisers remain in the list, program flow returns to step 305 and the process is repeated for the next advertisement.

If priority scores have been computed for advertisements in the list, the advertisements are ranked according to the computed priority scores, step 310. The list of advertisements and priority scores may be ranked via any sorting algorithm known to one of ordinary skill in the art, such as quick sort, merge sort, heap sort, etc.

The ordered and ranked advertisements may be placed within a search result page framework, steps 311-314, or any other content page framework. The highest ranked advertisement is popped from the stack of ranked advertisements, step 311, and a determination is made as to whether a free slot exists on the search results page, step 312. As previously described, a search results page may comprise multiple positions for advertisements such as the top of the page, the bottom of the page and the right hand side of the search results, etc. If no slots are available the page has been filled with the advertisements and the advertisements are provided along with the search results, step 315.

If at least one empty slot exists, the selected advertisement is placed within the open slot, step 313. A check is then performed to determine whether there are additional advertisements for placement that remain, step 314. In some cases, there may be more slots than advertisements due to the lack of interest in certain keywords. In this case, advertisements are supplied to the content page and empty slots may remain. Alternatively, where there are more advertisements than available slots, one or more selected advertisements may not be placed on the page. Once all advertisements have been supplied (or all slots filled), the search results and advertisements are provided to the user, step 315.

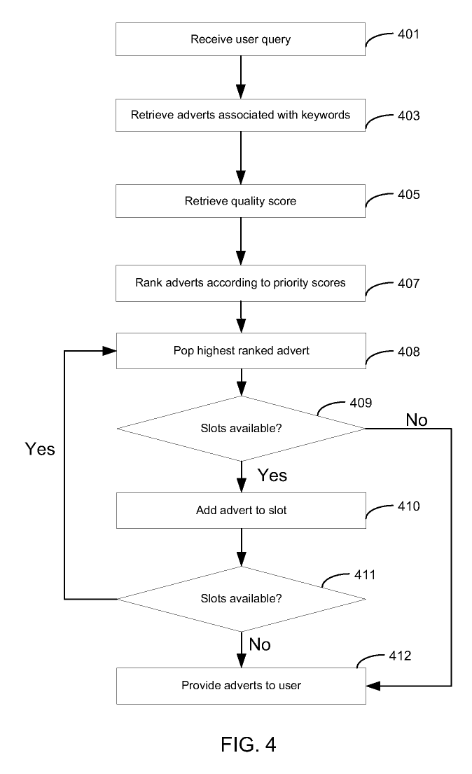

FIG. 4 is a flow diagram illustrating one embodiment of a method for statically ranking and providing advertisements in a position auction. A user query is received, step 401. A user query may correspond to the search terms requested of a search engine, such as through an HTML text box. A list of advertisements corresponding to the one or more keywords is retrieved, step 403, in conjunction with priority scores for corresponding advertisements, step 405.

The priority score retrieved in step 405 may be calculated prior to the execution of the user search. For example, in accordance with one embodiment, a batch process may be run which calculates the priority scores for advertisers corresponding to a search keyword. By calculating the priority scores as a batch process, the execution of a user search (and subsequently the speed at which results are returned) may be optimized as the computing power utilized by the steps of computing priority scores for a given advertiser on the fly is removed.

The advertisements may be ranked according to the priority scores, step 407. The ranked advertisements may then be placed within a search result page framework, steps 408-411. The highest rank advertisement may be popped from the stack of ranked advertisements, step 408. It is then determined if a free slot exists on the search results page, step 409. As previously described, a search results page may comprise multiple positions for advertisements. If no slots are available, the page has been filled with the highest priority advertisements and the advertisements are provided along with the search results, step 412.

If there one or more empty slots exist on the page, the selected advertisement is placed within the open slot, step 410. A check is then performed to determine whether there are any more advertisements remaining, step 411. In some cases, there may be more slots than advertisements due to the lack of interest in certain keywords, or vice versa. In this case, advertisements are supplied to the content page and empty slots remain unfilled. Once advertisements have been supplied (or slots filled), the search results and advertisements are provided to the user, step 412.

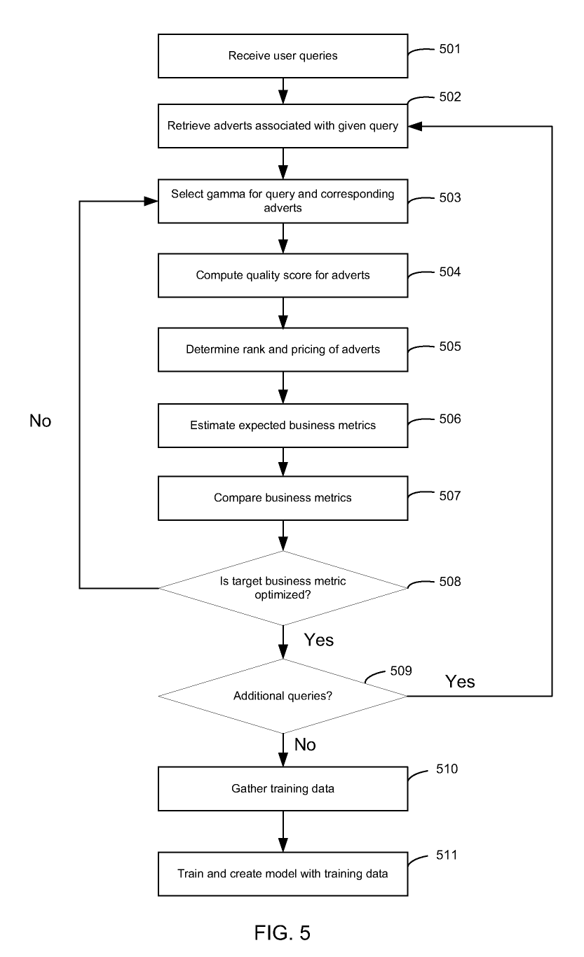

FIG. 5 presents a flow diagram illustrating one embodiment of a method for training an offline simulator to create one or more machine learned models, which may be used to predict optimal gamma values. A user query is received, step 501, which may correspond to the search terms requested of a search engine, such as through an HTML text box. A list of advertisements corresponding to the one or more keywords is retrieved and features of the advertisements are extracted, step 502, with the user query and advertisements used as a training set for the offline simulator. A training gamma value is selected for the retrieved list of advertisements and user query, step 503.

Quality scores are computed for the advertisements contained in the list of advertisements, step 504. The computed quality score is used to determine the rank and pricing of the listed advertisements, step 505. The training gamma value selected is used to estimate expected business metrics, step 506. Expected business metrics may be any advertising measurement known to one of ordinary skill in the art, such as RPS, PPC, CTR, etc. Comparisons are made between the business metrics, step 507. Comparisons may be made by determining the relationship between certain training gamma values and the corresponding expected business metrics. To obtain an optimized target business metric, a trade-off between one or more additional business metrics may be necessary. The expected business metrics are compared to expected business metrics of other training gamma values. The comparison may be used to determine the best trade-off between the expected business metrics to determine a gamma value, which provides for a optimized target business metric.

It is then determined if the target business metric is optimized, step 508. In one embodiment, the target business metric is RPS such that maximum revenue is achieved. In another embodiment, a plurality of target business metrics may be optimized. In yet another embodiment, determining optimized target business metric may include a tradeoff or a weighted combination between a plurality of target business metrics.

If the target business metric is not optimized, another training gamma value is selected, step 503. In one embodiment, training gamma values are selected from an upper bound to a lower bound until an optimized target business metric has been determined. If the target business metric is optimized, step 508, a final gamma value is recorded for the given user query and it is determined if the offline simulation training is complete, step 509. In some embodiments, the offline simulation requires multiple iterations of training and if additional queries are remaining, more training sets may be retrieved, step 502. Once the offline simulator has finished the training procedure, all the queries, extracted ad features, as well as, final training gamma values are gathered as training data, step 510. Training data gathered from step 510 are utilized to train and create machine learned model 1028, step 511.

Through the learning process of the offline simulator, a predictive formula is created in the form of machine learned model 1028. Machine learned model 1028 mimics the functionality of the offline simulator. An optimal gamma value is the Model's replication of a training gamma value if a query was directly analyzed by the offline simulator. However, instead of performing all the steps taken by the offline simulator for each query, the machine learned model 1028 simply predicts an optimal gamma value. The machine learned model 1028 attempts to predict training gamma values without the calculations necessary by the offline simulator.

In one embodiment, the machine learned model 1028 that the offline generator generates is used to predict optimal gamma values with respect to a target business metric, which may be used to rank advertisements. Advertisement ranking may be used as a parameter to determine the display order of advertisements in response to a user search query. The time and cost of finding gamma values for queries and advertisements is very high and the training process may take hours to days to complete. Accordingly, models generated by the offline simulator are trained to find a gamma value in a fraction of the time taken by the offline simulator. However, in another embodiment, the offline simulator itself may be used to predict optimal gamma values for user queries.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A system for ranking and providing advertisements in a position auction, the system comprising:
an offline simulator operable to,
receive a set of queries,
receive a corresponding set of advertisements to the queries,
compute a training scoring factor,
analyze the training scoring factor, and
generate a model operable to predict one or more optimal scoring factors; and
a rank generator operable to,
compute a priority score corresponding to an advertisement associated with a given bid comprising an optimal scoring factor predicted by the model, and
rank the advertisement according to the priority score.

2. The system according to claim 1 wherein the offline simulator is operative to compute the training scoring factor to meet a business metric criterion.

3. The system according to claim 2 wherein the business metric criteria comprises revenue per search.

4. The system according to claim 1 wherein the offline simulator is operative to compute the training scoring factor to meet a plurality of business metric criteria.

5. The system according to claim 4 wherein the offline simulator is operative to compute the training scoring factor to apply a weighted combination of the plurality of business metric criteria.

6. The system according to claim 4 wherein the plurality of business metric criteria comprises revenue per search, click through rate and price per click.

7. The system according to claim 1 wherein the optimal scoring factor is a predictive replication of the training scoring factor.

8. The system according to claim 1 wherein the offline simulator is operative to retrieve the set of queries and the corresponding set of advertisements to the queries at random intervals of time.

9. The system according to claim 1 wherein the offline simulator is operative to retrieve the set of queries and the corresponding set of advertisements to the queries at periodic intervals of time.

10. The system according to claim 1 wherein the offline simulator is operative to compute the training scoring factor by selecting values between an upper bound and a lower bound.

11. A method for ranking advertisements in a position auction comprising:
receiving a set of search queries;
receiving a corresponding set of advertisements to the queries;
computing a training scoring factor;
analyzing the training scoring factor;
generating a model operable to predict one or more optimal scoring factors;
computing a priority score corresponding to an advertisement associated with a given bid, the priority score comprising an optimal scoring factor predicted by the model; and
ranking the advertisement according to the priority score.

12. The method according to claim 11 wherein the training scoring factor is computed to meet a business metric criterion.

13. The method according to claim 12 wherein the business metric criteria comprises revenue per search.

14. The method according to claim 11 wherein the training scoring factor is computed to meet a plurality of business metric criteria.

15. The method according to claim 14 wherein the training scoring factor is computed to apply a weighted combination of the plurality of business metric criteria.

16. The method according to claim 14 wherein the plurality of business metric criteria comprises revenue per search, click through rate and price per click.

17. The method according to claim 11 wherein the optimal scoring factor is a predictive replication of the training scoring factor.

18. The method according to claim 11 wherein the set of queries and the corresponding set of advertisements to the queries are retrieved at random intervals of time.

19. The method according to claim 11 wherein the set of queries and the corresponding set of advertisements to the queries are retrieved at periodic intervals of time.

20. The method according to claim 11 wherein the training scoring factor is computed by selecting values between an upper bound and a lower bound.
